(19) United States
(12) Patent Application Publication
(10) Pub. No.: US 2024/0110291 A1
(43) Pub. Date: Apr. 4, 2024

(54) PROCESS AND SYSTEM FOR PRODUCING ONE OR MORE ELECTROLYSIS PRODUCTS

(71) Applicant: Linde GmbH, Pullach (DE)

(72) Inventors: Andreas WOLF, Pullach (DE); Anton WELLENHOFER, Pullach (DE); Christian FRUHMANN, Pullach (DE); Daniela LAUCHNER, Pullach (DE); Marius DILLIG, Pullach (DE); Mariyana CHALAKOVA, Pullach (DE); Ole MÜLLER-THORWART, Pullach (DE); Robert BIRK, Pullach (DE); Robert HERZOG, Pullach (DE)

(21) Appl. No.: 18/472,976

(22) Filed: Sep. 22, 2023

(30) Foreign Application Priority Data
Sep. 29, 2022 (EP) 22020472.1

(51) Int. Cl. C25B 1/04; C25B 9/19; C25B 15/08

(52) U.S. Cl. CPC C25B 1/04; C25B 9/19; C25B 15/083

(57) ABSTRACT

A method is proposed for producing one or more electrolysis products, wherein one or more electrolytic cells having a proton exchange membrane is/are used, wherein a hydrogen-rich cathode extraction gas is extracted on the cathode side of the one or more electrolytic cells, wherein an anode extraction gas is extracted on the anode side of the one or more electrolytic cells, wherein the anode extraction gas is extracted from the one or more electrolytic cells as part of a two-phase flow, wherein the two-phase flow comprises the anode extraction gas and a water phase, and wherein the two-phase flow or part thereof is separated in a separator arrangement into the anode extraction gas and the water phase.

### CROSS-REFERENCE TO RELATED APPLICATIONS

This application claims priority pursuant to 35 U.S.C. 119(a) to European Application No. 22020472.1, filed Sep. 29, 2022, which application is incorporated herein by reference in its entirety.

### FIELD

The present invention relates to a method and to a plant for producing one or more electrolysis products, in particular hydrogen and/or oxygen, using one or more electrolytic cells, in particular one or more electrolytic cells having a proton exchange membrane.

### BACKGROUND OF THE INVENTION

The production of hydrogen using electrolytic cells having proton exchange membranes (PEM) is known. In corresponding electrolytic cells, the proton exchange membrane, which serves for conducting protons, for separating the product gases and for electrically insulating the anode side and cathode side from one another, is formed by a solid polymer electrolyte. By using electrolytic cells having proton exchange membranes, some of the problems with regard to partial load operation and the low flow densities that are possible and occur in conventional alkaline electrolysis can be overcome.

Due to the comparatively high pressure of the hydrogen formed when electrolytic cells having a proton exchange membrane are used, consumers can be supplied directly with power. The high flow densities that can be used lead to comparatively low operating costs, in particular in cases in which dynamic electrical energy sources such as wind and sun are used, the power peaks of which can otherwise not be used. The polymer electrolyte enables the use of thin membranes of, for example, approximately 100 to 200 μm, alongside simultaneously high pressures. This leads to low ohmic losses, which are primarily caused by the conduction of protons through the membrane and the formation of pressurized hydrogen.

Due to its solid structure, the polymer electrolyte membrane has a low gas transition rate, which can lead to very high product gas purity. This can be advantageous in particular as regards storage safety and direct use, for example in a fuel cell.

Voltage losses in a corresponding electrolytic cell can occur in particular due to internal electrical resistances, proton conductivity, mass transfer through the cell and catalyst utilization.

The anode reaction in an electrolysis cell having a proton exchange membrane is commonly referred to as an oxygen evolution reaction (OER). At the anode, the liquid reactant water is fed to the catalyst and oxidized to form oxygen, protons and electrons:

2H₂O(l)→O₂(g)+4H⁺(aq)+4e⁻

The cathode reaction is commonly referred to as a hydrogen evolution reaction (HER). In this case, the supplied electrons are combined with the protons conducted through the membrane, thereby producing gaseous hydrogen:

4H⁺(aq)+4e⁻→2H₂(g)

In addition to hydrogen from the cathode side, the oxygen formed on the anode side of corresponding electrolysis cells can also be used. The present invention can relate to the recovery of hydrogen on the cathode side and oxygen on the anode side of a corresponding electrolysis.

The object of the present invention is to improve the production of hydrogen and/or oxygen, in particular using electrolytic cells having a proton exchange membrane, and in particular to make it safer and more reliable.

### DISCLOSURE OF THE INVENTION

Against this background, the present invention proposes a method and a plant for producing one or more electrolysis products, in particular hydrogen and/or oxygen, and in particular using an electrolytic cell having a proton exchange membrane, said method and plant having the features of the independent claims. Each of the embodiments are the subject matter of the dependent claims and of the description below.

Although the present invention is described below predominantly with reference to an electrolysis in which a proton exchange membrane is used, embodiments of the present invention can, in principle, also be employed using other electrolysis techniques, in particular when problems which are addressed in the present invention occur in an identical or similar manner. The reference to an electrolysis having a proton exchange membrane is made only for the sake of simplification and without any intention to restrict the present invention thereto.

If the term “an” electrolytic cell, in particular having “a” proton exchange membrane (in each case in the singular), is mentioned here, this should be understood to mean that embodiments of the present invention are typically realized having a plurality of such cells, wherein corresponding cells can in particular be part of a known type of cell stack, in which a plurality of such cells are present. In such a stack, in an electrolysis using proton exchange membranes, a multiplicity of arrangements—each consisting of an anode, proton exchange membrane and cathode—is provided, which are each separated from one another by separation devices and means for feeding water or removing gas. The latter can be connected to feed or collecting lines, which supply the entire stack with power. In other types of electrolysis, a similar stack structure can be provided and corresponding feed and collecting lines can also be used here.

Therefore, if in the present case an “anode side” or “cathode side” of an electrolysis cell of any kind is mentioned, these terms can also denote the cathode sides or anode sides of the cells of corresponding cell stacks collectively. A gas extracted from this/these cathode side(s) (collectively) is also referred to below as “cathode extraction gas.” The same applies to the anode side, i.e., an “anode extraction gas.”

The cathode extraction gas is hydrogen-rich, the anode extraction gas oxygen-rich, but the anode extraction gas typically has more hydrogen than the cathode extraction gas has oxygen, because hydrogen typically transitions more easily to the anode side than the oxygen transitions to the cathode side. As mentioned, high product purities can be achieved by the use of proton exchange membranes and therefore the cathode extraction gas contains very little oxygen. However, hydrogen-rich or oxygen-rich cathode or anode extraction gases each containing the other gas in a lower proportion can also be formed in other electrolysis techniques. The term “rich” can in particular be a content of more than 90%, 95%, 99% or 99.5% on a volumetric, quantity or molar basis.

The anode extraction gas is extracted, in particular in the electrolysis comprising proton exchange membranes, together with water on the anode side, i.e., a two-phase flow is first performed by the anode side. After separation into a gas and liquid phase, the former can be supplied, for example, to an oxygen recovery process or to the atmosphere.

A main problem with regard to the two-phase flow which has oxygen and water results from its possible hydrogen content. Driven by the pressure gradient through the proton exchange membrane, for example, hydrogen can pass through this proton exchange membrane, albeit by permeation, but increased when defects or cracks occur. For example, in scenarios of low load, in standby or in the case of defects, this hydrogen content may possibly reach the lower explosion limit (LEL) of about 4% hydrogen in oxygen. A corresponding transition of hydrogen can, in principle, also occur in other electrolysis techniques.

The (lower) explosion limit of a gas indicates the content in a gas mixture from which ignition or explosion is possible if the oxygen content is sufficient at the same time. The latter is always the case when it comes to oxygen-rich anode extraction gas or the aforementioned two-phase flow.

An explosion is an uncontrolled burn-off of a flammable gas mixture with a laminar flame front. An explosion essentially differs from a detonation by the speed of the propagation.

In the case of an explosion, this is below the speed of sound, in the case of a detonation typically significantly above the speed of sound. As a result of explosions and detonations of gas mixtures in containers and tubes, a massive increase in pressure occurs which can result in the containers rupturing and corresponding consequential damages. Typically, in an explosion, a pressure increase by a factor of ten can be assumed. The effects of a detonation are significantly more severe. Here, the pressure increase factor may be 50 or more. An explosion may morph into a detonation after a certain start-up length and a minimum concentration of fuel and oxygen.

An ignition source in the region within, and downstream of, an electrolytic cell, for example having a proton exchange membrane or a corresponding stack, cannot be completely ruled out. Thus, the possible ignition of the explosive gas mixture must be assumed when designing a corresponding plant.

The oxyhydrogen gas reaction proceeds very quickly, resulting in very rapidly increasing flame velocities, which are above the speed of sound. Therefore, an explosion even in small rooms and tubes can turn into a detonation. For a detonation scenario, very high explosion pressure conditions must be taken into account in the design.

In this case, even when an explosion or detonation occurs “only” in a separator for separating the two-phase flow, damage in other regions, in particular downstream apparatuses such as pumps or heat exchangers or an electrolytic cell or a stack itself, can result because the explosion pressure is transferred thereto via the incompressible fluid (water).

The present invention enables safer solutions for such cases and thereby overcomes the disadvantages of the prior art. Traditionally, a corresponding explosion-proof or detonation-proof design is at best very expensive and at worst technically impossible to implement. Protection of downstream apparatuses by pressure relief valves or rupture disks can traditionally also be problematic, because the pressure wave of the explosion or detonation propagates very quickly, i.e., at approximately 3000 m/s.

In the presently proposed method for producing one or more electrolysis products, in particular hydrogen and/or oxygen, one or more electrolytic cells is/are used, in particular having a proton exchange membrane, wherein a hydrogen-rich cathode extraction gas is extracted on the cathode side of the one or more electrolytic cells, wherein an anode extraction gas is extracted on the anode side of the one or more electrolytic cells, wherein the anode extraction gas is extracted from the one or more electrolytic cells as part of a two-phase flow, wherein the two-phase flow has the anode extraction gas and a water phase, and wherein the two-phase flow, or part thereof, is separated in a separator arrangement into the anode extraction gas and the water phase. The anode extraction gas is oxygen-rich and has a certain hydrogen content due to the effects explained, i.e., a certain hydrogen content cannot be completely prevented.

In this case, it is provided that a separator arrangement having a first portion, which has a first gas chamber and a first liquid chamber, and a second portion, which has a second gas chamber and a second liquid chamber, is used as the separator arrangement, wherein the separator arrangement is designed such that, when the first liquid chamber and the second liquid chamber are filled, a liquid seal is formed which interrupts gas contact between the first gas chamber and the second gas chamber. The liquid seal can be formed, for example, by a dam and a submerged wall, which goes down into the first liquid chamber, by an overflow tube or by a riser tube, as explained below in each case on the basis of corresponding embodiments.

In embodiments of the invention, a plurality of corresponding first portions, each having a first gas chamber and a first liquid chamber, can also be provided, and two or more first portions can be assigned to a common second portion having a second gas chamber and a second liquid chamber. In this case, the gas chambers of the plurality of first portions are each separated from the common second gas chamber by a liquid seal. The plurality of first portions can also be formed on two sides of a common second portion and can be substantially mirror-inverted, as illustrated in embodiments in FIGS. 4 and 6. In the following, only for the sake of simplicity will “a” first portion be referred to in the singular.

In the case of an explosion or detonation, liquid can be pushed out of the first liquid chamber of the first portion and into the second portion. Due to the second gas chamber present in the second portion, said second portion can serve as a buffer so that the pressure wave is not directly relayed via the liquid phase. In this way, damage to downstream apparatuses can be avoided.

In principle, different designs of separator arrangements and liquid seals can be used. In embodiments of the invention, a separator arrangement is designed in particular such that the water phase in the first portion accumulates at a dam or a second partition wall up to an accumulation height and runs over the second partition wall and into the second portion. The first and the second gas chambers are separated from one another by a first partition wall which goes down below the liquid level in the first portion and the first partition wall and the second partition wall form the liquid seal. In particular, such a separator arrangement can therefore have a first partition wall and a second partition wall, wherein the liquid seal is formed by the first partition wall and the second partition wall. In this way, a separator arrangement which can be produced in this way in a particularly simple, stable and cost-effective manner can be formed by only a pressure-resistant outer wall and two partition walls.

In a corresponding embodiment of the present invention, the separator arrangement can thus have an interior space enclosed by a wall, wherein the first partition wall only divides an upper part of the interior space in a fluid-tight manner, wherein the second partition wall only divides a lower part of the interior space in a fluid-tight manner, and wherein the regions divided in a fluid-tight manner by the first partition wall and the second partition wall overlap one another. In this case, the overlap can only be brought about by an embodiment in which the partition walls terminate at different heights.

In this case, the second partition wall can divide the lower part of the interior space in a fluid-tight manner up to an accumulation height and the first partition wall can divide the upper part of the interior space in a fluid-tight manner up to an immersion height, wherein the immersion height is arranged geodetically below the accumulation height.

During operation, the water phase in the first portion can be accumulated up by means of the second partition wall up to the accumulation height so that the first partition wall goes down into a liquid level of the water phase that forms at the accumulation height. Advantageously, the water phase remains accumulated by a corresponding feed being ensured and the liquid seal thus always remains closed.

In embodiments of the invention, the second portion can be filled, at least partially, by means of an overflow stream of the water phase from the first portion over the second partition wall. An additional water feed can also be provided, for example to compensate for shortfalls and to avoid cavitation of the downstream pump.

In the second portion, in particular a liquid level of the water phase is formed which lies below the liquid level of the water phase in the first portion, in particular in order to prevent a backflow and to ensure a sufficient buffer volume. This can be ensured by setting an extraction amount.

In other embodiments, the separator arrangement can have an overflow tube which forms the liquid seal by it being immersed, for example, into the liquid accumulated in the second liquid chamber.

In a specific embodiment of the present invention, a first portion can in particular be formed by a cylindrical container having one or two dome-like or spherical segment-like terminal caps, which container has a horizontally oriented cylinder axis. The first portion can have a first diameter perpendicularly to the cylinder axis. Following the first portion, the second portion can also be cylindrical, wherein a cylinder axis of the second portion can in particular also be oriented horizontally. The second portion can have a second diameter perpendicularly to the cylinder axis, which is in particular greater than the first diameter. From a region which lies below a plane defined by the cylinder axis of the first section, a riser tube can be routed out of the first portion, in particular out of a terminal cap, the remainder of which riser tube curves upward and which tube opens into the second portion. In this case, the arrangement is operated in particular such that an amount of liquid is fed into the first portion and an amount of liquid is extracted from the second portion these amounts being measured in such a way that a liquid level is formed which lies below the mouth of the riser tube in the second portion.

The embodiment just explained may comprise, in particular, two substantially identical and mirror-inverted first portions and an intermediate central second portion so that the riser tubes lead from the first portions and into the central second portion. The explanations also apply analogously to more than two first portions, which can then be arranged, for example, in a triangular, cross-shaped or star-shaped pattern or in a row around a second portion.

The two-phase flow or the part thereof fed into the separator arrangement is fed into the first portion, the anode extraction gas is extracted from the first gas chamber and the water phase is extracted from the second portion. The gas chamber of the second portion can be connected via a line to the surrounding atmosphere, wherein a corresponding line can discharge gas to the outside in particular during an explosion or detonation.

The present invention is suitable, as mentioned, for preventing consequences of an explosion or detonation, even when the cathode extraction gas has, at least temporarily, a hydrogen content of more than 4% and oxygen for the remainder.

A plant for producing one or more electrolysis products, in particular hydrogen or hydrogen and oxygen, which has one or more electrolytic cells, in particular having a proton exchange membrane, likewise forms the subject matter of the invention, wherein the plant has means which are configured to extract a hydrogen-rich cathode extraction gas on the cathode side of the one or more electrolytic cells and to extract an anode extraction gas on the anode side of the one or more electrolytic cells, wherein the anode extraction gas is part of a two-phase flow, which comprises the anode extraction gas and a water phase, and wherein the plant has a separator arrangement which is configured to separate the two-phase flow or part thereof into the anode extraction gas and the water phase.

In this case, the separator arrangement is formed having a first portion, which has a first gas chamber and a first liquid chamber, and having a second portion, which has a second gas chamber and a second liquid chamber, wherein the separator arrangement is designed such that a liquid seal is formed when the first liquid chamber and the second liquid chamber are filled, which liquid seal interrupts gas contact between the first gas chamber and the second gas chamber.

For further features and advantages of a corresponding plant and embodiments thereof, reference is expressly made to the above explanations relating to the method proposed according to the invention and its embodiments, since they apply in the same way here.

The same also applies to a plant which, according to one embodiment of the invention, is configured to carry out a method according to any embodiment of the present invention.

### BRIEF DESCRIPTION OF THE DRAWING

Embodiments of the invention will be described below purely by way of example and with reference to the accompanying drawings, in which

FIG. 1 illustrates the background of the present invention,

FIG. 2 illustrates a plant according to one embodiment of the invention, and

FIGS. 3 to 6 show possible details of the plant according to FIG. 2.

### EMBODIMENTS OF THE INVENTION

The embodiments described below are only described for the purpose of supporting the reader in understanding the features that are claimed and explained above. They are merely representative examples and are not intended to be considered to be exhaustive and/or limiting with respect to the features of the invention. It goes without saying that the advantages, embodiments, examples, functions, features, structures and/or other aspects described above and below are not to be considered to limit the scope of the invention as defined in the claims, or to limit equivalents to the claims, and that other embodiments may be used and changes made without departing from the scope of the claimed invention.

Different embodiments of the invention may comprise, have, consist of, or substantially consist of further expedient combinations of the described elements, components, features, parts, steps, means, etc., even if such combinations are not specifically described herein. Furthermore, the disclosure may comprise other inventions that are presently not claimed, but which may be claimed in the future, in particular when included in the scope of the independent claims.

Explanations relating to devices, apparatuses, arrangements, systems, etc. according to embodiments of the present invention may also apply to procedures, processes, methods, etc. according to the embodiments of the present invention, and vice versa. Identical elements, method steps etc., which operate in the same manner, correspond in terms of their function and have an identical or similar design, can be given identical reference signs.

The present invention and embodiments thereof will be explained below with reference to an electrolysis comprising a proton exchange membrane. As mentioned several times, however, the invention is not limited to this.

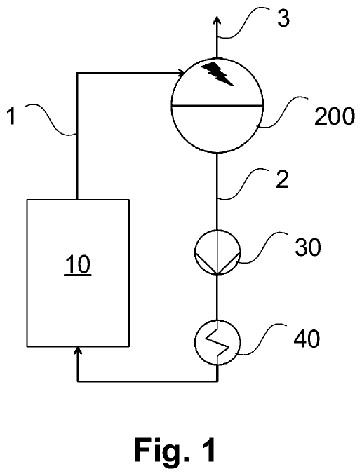

FIG. 1 illustrates a on the basis of a highly simplified flow chart the background of the present invention

FIG. 1 illustrates the water or oxygen circuit on the anode side of an electrolytic cell having a proton exchange membrane. The electrolytic cell or a corresponding stack of a plurality of electrolytic cells is indicated by 10. Details and cathode extraction gas extracted on the cathode side, which is substantially pure hydrogen, is not illustrated.

As already explained above, a two-phase flow 1 having a water and a gas fraction is first formed on the anode side from the electrolytic cell or stack 10. In addition to oxygen, hydrogen also occurs in the gas fraction due to permeation through the proton exchange membrane, and even more so when there are defects in the proton exchange membrane.

The two-phase flow is fed into a separator 200, in the lower region of which the water fraction of the two-phase flow 1 separates out so that it can be extracted as a water flow 2 (with certain residual fractions of dissolved gases). The water flow 2 can be circulated by means of a pump 30 and temperature-controlled by means of a heat exchanger 40.

The gas fraction can be designed in the form of a gas flow 3 and, depending on the embodiment of the method, can be used to form an oxygen product or be discarded by releasing it into the atmosphere.

As illustrated by a jagged arrow, an explosion or detonation can take place in a gas chamber in the separator 200, but also in the corresponding lines when there is a corresponding amount of hydrogen in the gas flow 3. As mentioned, even if an explosion or detonation occurs “only” in the separator 200, damage in other regions, in particular downstream apparatuses such as the pump 30, the heat exchanger 40 or the electrolytic cell or the stack 10, can result because the explosion pressure is transferred thereto via the incompressible fluid (water).

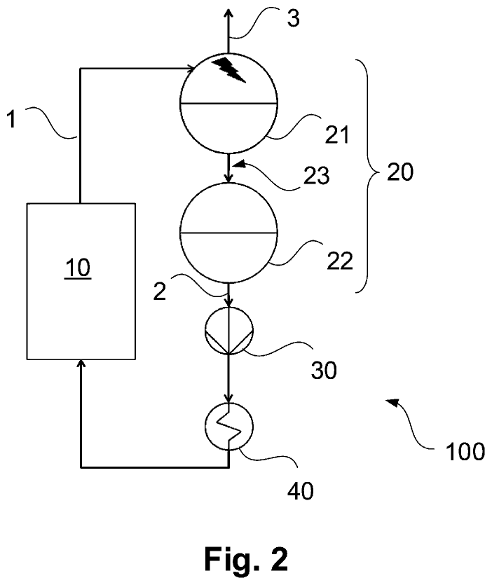

FIG. 2 illustrates a plant according to one embodiment of the present invention and is designated as a whole by 100. The elements already explained in relation to FIG. 1 where they are given corresponding designations, i.e., the electrolytic cell or stack 10, the pump 30 and the heat exchanger 40, will not be explained again.

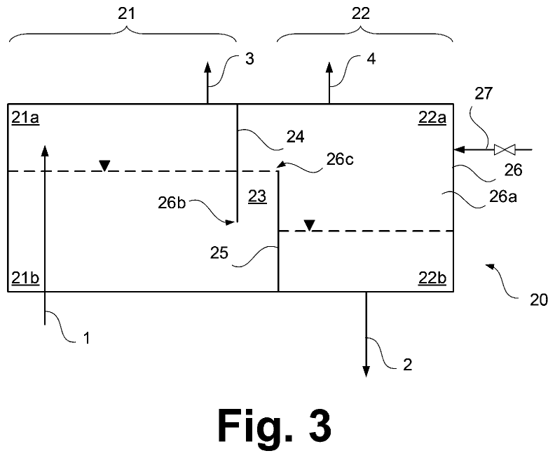

As illustrated in FIG. 2, the plant 100 has a separator arrangement 20 which is formed from a first portion 21 and a second portion 22, each of which comprises a gas chamber and a liquid chamber. A liquid seal 23 is formed between the portions 21 and 22. In other words, the separator arrangement 20 is designed in such a way that, during the filling process during operation of the plant 100, a liquid seal 23 is formed which interrupts gas contact between the gas chambers in the first and second portions 21 and 22. Details of a possible embodiment are illustrated in the following figures, FIGS. 3 to 6. In this way, the region downstream of the first portion 21 can be kept free of explosive or detonation-capable gas mixtures.

Therefore, in the plant illustrated in FIG. 2, only the region of the two-phase flow 1 and the first portion 21 with the elements directly connected thereto must be designed to be explosion-resistant or detonation-resistant, and in particular in the case of an explosion or detonation in the first portion 21, the pressure wave cannot pass through or can pass through only to a reduced extent to the downstream elements, such as the pump 30 and the heat exchanger 40. This is achieved by a gaseous buffer volume being created in the second portion 22, and the direct connection between the two liquid chambers being interrupted.

FIG. 3 illustrates a separator arrangement 20 that can be used, for example, in a plant 100 according to FIG. 2 and the integration of which results from the flows 1, 2 and 3, which have the same designations as in FIG. 2. A further gas flow is designated as 4 in FIG. 3.

The separator arrangement 20 has a wall 26 in which two chambers are formed which form the first portion 21 and the second portion 22. The liquid seal 23 is formed by two partition walls, wherein a first partition wall 24 separates a gas chamber 21a of the first portion 21 from a gas chamber 22a of the second portion 22. In contrast, the second partition wall 25 separates a liquid chamber 21b of the first portion 21 from a liquid chamber 22b of the second portion 22.

Liquid levels in the first portion 21 and the second portion 22 are each illustrated in dashed lines and also designated using triangles. If an explosion or detonation then occurs in the first portion 21, liquid flows from the liquid chamber 21b of the first portion 21 into the liquid chamber 22b of the second portion 22, but the explosion pressure wave cannot pass through to the downstream apparatuses. Gas from the gas chamber 22a of the second portion 22 can escape in the form of the gas flow 4.

If necessary, additional water can be fed into the second portion 22 or the liquid chamber 22b thereof via a line 27 or a valve (not designated separately) arranged therein, for example in order to replace water split off in the electrolysis process.

In other words, an interior space 26a is enclosed by the wall 26. The first partition wall 24 divides only an upper part of the interior space 26a in a fluid-tight manner and the second partition wall 25 divides only a lower part of the interior space 26a in a fluid-tight manner, wherein the regions divided in a fluid-tight manner by the first partition wall 24 and the second partition wall 25 overlap each other when viewed horizontally.

More precisely, the second partition wall 25 divides the lower part of the interior space 26a up to an accumulation height 26c and the first partition wall 24 divides the upper part of the interior space 26a up to an immersion height 26b. The immersion height 26b is arranged geodetically below the accumulation height 26c so that the water phase 2 in the first portion 21 can be accumulated by means of the second partition wall 25 up to the accumulation height 26c, and the first partition wall 24 goes down into a liquid level of the water phase 2 that forms in the accumulation height 26c.

The second portion 22 is at least partially filled by an overflow stream of the water phase 2 over the second partition wall 25 from the first section 21. Furthermore, water can be fed in via line 27. In any case, a liquid level of the water phase is formed in the second section 22 that lies below the liquid level of the water phase in the first portion 21.

The two-phase flow 1 is fed into the first portion 21 and the anode extraction gas 3 is extracted from the first gas chamber 21a. The water phase 2 is discharged from the second portion 22, in particular to a pump 30. The liquid level in the second liquid chamber 22b is set according to the extracted amount in the form of the flow 2.

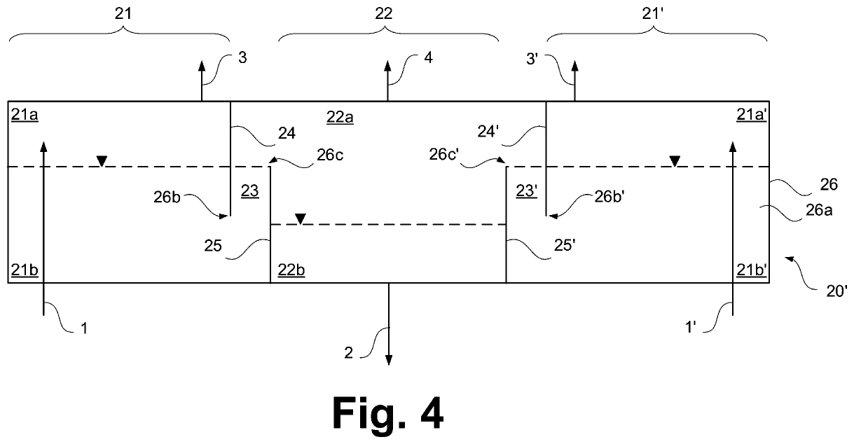

FIG. 4 illustrates a further separator arrangement, which can be used, for example, in a plant 100 according to FIG. 2 but which is denoted here by 20′. This has a symmetrical structure, wherein a further first portion is provided which as a whole is provided with 21′ and the components of which are provided with corresponding reference signs with apostrophes. The integration results from the flows 1, 2 and 3, which are identical to those designated in FIG. 2, or flows 1′ and 3′, which are correspondingly designated with apostrophes. The separator arrangement 20′ according to FIG. 4 is suitable in particular for connecting a plurality of electrolytic cells or stacks 10 to a common pump 30.

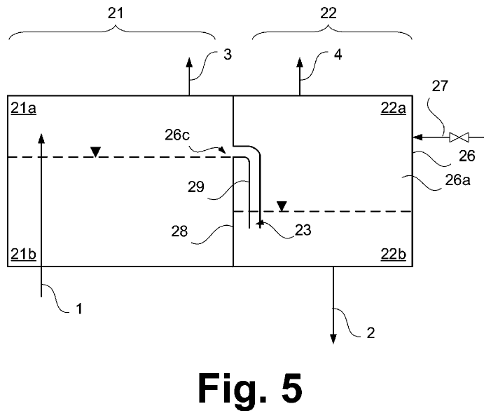

FIG. 5 illustrates a further separator arrangement, which can be used, for example, in a plant 100 according to FIG. 2 but which is not designated separately in FIG. 5. This has an overflow tube 29, wherein liquid in the first liquid chamber 21b is accumulated up to the accumulation height, also designated here as 26c, and wherein the overflow tube 29 goes down the in the liquid chamber 22b in the second portion 22 and thereby forms the liquid seal 23.

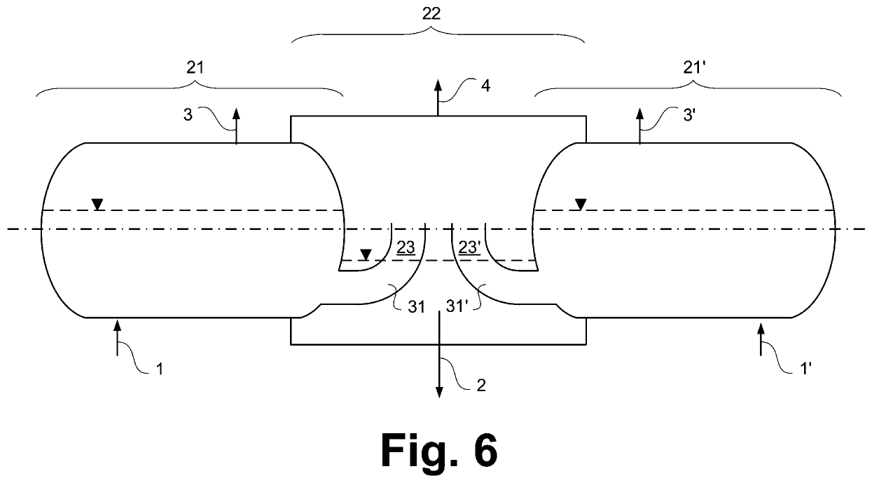

FIG. 6 illustrates a further separator arrangement, which can be used, for example, in a plant 100 according to FIG. 2 and which is not designated separately in FIG. 6 either.

In the specific embodiment of the present invention illustrated here, a first portion 21 (a corresponding, mirror-imaged further second section 21′ can be present, but is not explained separately) is formed in particular by a cylindrical container having one or two dome-like or spherical segment-like terminal caps and the cylinder axis, shown in FIG. 6 by a dot-dash line, of which is oriented horizontally. The first portion 21 can have a first diameter perpendicularly to the cylinder axis.

Following the first portion, a second portion 22, can be provided that is in particular likewise cylindrical but can also have any desired design wherein a cylinder axis of the second portion can, in particular, likewise be oriented horizontally and this coincides, for example, with the cylinder axis of the first portion. The second portion 22 can have a second diameter perpendicularly to the cylinder axis, which is in particular greater than the first diameter.

From a region which lies below a plane defined by the cylinder axis of the first portion 21, a riser tube 31 can be routed out of the first portion, in particular out of a terminal cap, and the remainder of which curves upward and which tube opens into the second portion 22. In this case, the arrangement is operated in particular in such a way that an amount of liquid is fed into the first portion and that an amount of liquid is extracted from the second portion, these amounts each being measured such that a liquid level, illustrated here by dashed lines, is formed and lies below where the riser tube opens up into the second portion.

1. A method for producing one or more electrolysis products, wherein one or more electrolytic cells is/are used, wherein a hydrogen-rich cathode extraction gas is extracted on the cathode side of the one or more electrolytic cells, wherein an anode extraction gas is extracted on the anode side of the one or more electrolytic cells, wherein the anode extraction gas of the one or more electrolytic cells is extracted as part of a two-phase flow, wherein the two-phase flow has the anode extraction gas and a water phase, and wherein the two-phase flow or part thereof is separated in a separator arrangement into the anode extraction gas and the water phase, wherein a separator arrangement having a first portion, which has a first gas chamber and a first liquid chamber, and having a second portion, which has a second gas chamber and a second liquid chamber, is used as the separator arrangement, wherein the separator arrangement is designed such that, when the first liquid chamber and the second liquid chamber are filled, a liquid seal is formed which interrupts gas contact between the first gas chamber and the second gas chamber and, in particular, liquid contact between the first liquid chamber and the second liquid chamber is additionally prevented by the second gas chamber by means of a correspondingly controlled liquid level in the second portion.

2. The method according to claim 1, wherein one or more electrolytic cells having a proton exchange membrane are used.

3. The method according to claim 1, wherein the separator arrangement is designed such that the water phase accumulates in the first portion up to a accumulation height and runs into the second portion over a liquid seal.

4. The method according to claim 3, wherein the separator arrangement has a first partition wall and a second partition wall, wherein the liquid seal is formed by the first partition wall and the second partition wall.

5. The method according to claim 3, wherein the separator arrangement has an overflow tube which forms the liquid seal.

6. The method according to claim 1, wherein the first portion is formed by a cylindrical container, the cylinder axis of which is oriented horizontally and which has a first diameter perpendicularly to the cylinder axis thereof.

7. The method according to claim 6, wherein the cylindrical container has one or two dome-like or spherical segment-like terminal caps.

8. The method according to claim 6, wherein the second portion is formed by a further cylindrical container, in particular wherein a cylinder axis of the second section is oriented horizontally.

9. The method according to claim 8, wherein the second portion has a second diameter perpendicularly to the cylinder axis thereof that is greater than the first diameter.

10. The method according to claim 6, wherein a riser tube, the remainder of which curves upward and which tube opens into the second portion, is routed out of a region of the first portion which lies below a horizontal plane defined by the cylinder axis of the first portion.

11. The method according to claim 1, wherein the two-phase flow or the part thereof fed into the separator arrangement is fed into the first portion.

12. The method according to claim 1, wherein the anode extraction gas is extracted from the first gas chamber.

13. The method according to claim 1, wherein the water phase is extracted from the second portion.

14. The method according to claim 1, wherein, at least at times, the anode extraction gas has a hydrogen content of more than 4% and oxygen as the remainder.

15. A plant for producing one or more electrolysis products having one or more electrolytic cells, wherein the plant has means which are configured to extract a hydrogen-rich cathode extraction gas on the cathode side of the one or more electrolytic cells and to extract an anode extraction gas on the anode side of the one or more electrolytic cells, wherein the anode extraction gas is part of a two-phase flow that comprises the anode extraction gas and a water phase, and wherein the plant has a separator arrangement which is configured to separate the two-phase flow or part thereof into the anode extraction gas and the water phase, wherein the separator arrangement is formed having a first portion, which has a first gas chamber and a first liquid chamber, and having a second portion, which has a second gas chamber and a second liquid chamber, wherein the separator arrangement is designed such that, when the first liquid chamber and the second liquid chamber are filled, a liquid seal is formed which interrupts gas contact between the first gas chamber and the second gas chamber and in particular liquid contact between the first liquid chamber and the second liquid chamber is in particular also prevented by the second gas chamber by means of a correspondingly controlled liquid level in the second portion.
